(19) United States
(12) Patent Application Publication
(10) Pub. No.: US 2012/0150626 A1
(43) Pub. Date: Jun. 14, 2012

(54) System and Method for Automated Recommendation of Advertisement Targeting Attributes

(76) Inventors: Ruofei (Bruce) Zhang, Mountain View, CA (US); Yang Zhou, Santa Clara, CA (US); Xuerui Wang, Sunnyvale, CA (US)

(21) Appl. No.: 12/965,711

(22) Filed: Dec. 10, 2010

(51) Int. Cl. G06Q 30/00

(52) U.S. Cl. 705/14.42

(57) ABSTRACT

A system and method for recommending targeting attributes for advertising campaigns are provided. The system and method comprise receiving at least one advertizing campaign, receiving historical targeting data and historical click-through data, selecting a machine learning model, and determining recommended targeting attributes for the advertising campaign using the machine learning model and the received data. The machine learning model may be a collaborative filtering model or a performance oriented model. The collaborative filtering model may rely on matrix factorization or Boltzmann Machines. The performance-oriented model may rely on a local regression.

### FIELD OF THE INVENTION

The present invention relates to a method and system for providing automated recommendations of targeting attributes for online advertising campaigns. More particularly, the present invention relates to three unique machine-learning techniques for recommending targeting attributes for an advertising campaign using targeting attribute data for similar advertising campaigns or historical click through data for previous advertising campaigns.

### BACKGROUND

The Internet is now a ubiquitous medium of communication in most parts of the world. The emergence of the Internet has opened a new forum for the creation and placement of advertisements promoting products, services, and brands. Internet content providers rely on advertising revenue to drive the production of free or low-cost content. Advertisers, in turn, increasingly view Internet content portals and online publications as a critically important medium for the placement of advertising. The interactive nature of Internet communication enables advertisers and content providers to definitively target advertising campaigns to specific viewers and measure viewers' responses by analyzing metrics such as user click-through rate (CTR). Advertisers, advertising exchange services, and publishers use a number of techniques to ensure that advertisements are appropriately targeted and thus likely to yield a high CTR.

### SUMMARY OF THE INVENTION

The present invention introduces methods and systems for recommending targeting attributes for advertising campaigns using machine learning models.

According to one embodiment, at least one advertising campaign and a corresponding plurality of advertiser-specified targeting attributes are received from an advertising entity. The advertiser-specified targeting attributes specify criteria to select users to receive the advertising campaign and webpage content criteria for displaying the advertising campaign. Historical click-through data for previous advertising campaigns comprising click through rates and targeting attributes are further received. A machine learning model for the computation of recommended targeting attributes is selected. The machine learning model may be a collaborative filtering model or a performance-oriented model. Using the selected machine learning model and the historical click-through data, at least one recommended targeting attribute for an advertising campaign is determined.

According to an embodiment in which the selected machine learning model is a collaborative filtering model, the advertising campaigns and the advertiser-specified targeting attributes are modeled as an advertiser-specified targeting attributes matrix with at least one advertising campaigns vector and at least one targeting attributes vector. The advertiser-specified targeting attributes matrix comprises a plurality of binary values indicating whether a particular targeting attribute has been specified for a particular advertising campaign. The historical click-through data is modeled as an advertising campaign user attribute matrix with at least one advertising campaigns vector and at least one user attributes vector. The advertising campaign user attribute matrix comprises a plurality of values indicating the frequency that a particular user attribute occurred in clicks corresponding to a particular advertising campaign. The advertiser-specified targeting attributes matrix is factorized into a first factorized matrix and a second factorized matrix, wherein the advertising campaigns and the targeting attributes are mapped to a joint latent factor space comprising a plurality of latent factors. For each advertising campaign, using the first factorized matrix and the second factorized matrix, the targeting attributes are ranked based on a plurality of weight values in the first factorized matrix corresponding to the targeting attributes and each advertising campaign. In one embodiment, a threshold value is determined, and at least one targeting attribute whose corresponding weight value exceeds the threshold value is selected as the recommended targeting attribute for each advertising campaign. The advertiser-specified targeting attributes matrix may be factorized using an algorithm regularized to ensure consistency with the plurality of advertiser-specified targeting attributes, using Frobenius norm; consistency with similarity to user attributes; and/or sparseness of the latent factors, by regularizing the first factorized matrix and the second factorized matrix.

According to another embodiment in which the selected machine learning model is a collaborative filtering model, the advertising campaigns and the advertiser-specified targeting attributes are modeled as a plurality of advertiser-specified targeting attributes binary vectors. The advertiser-specified targeting attributes binary vectors comprise a plurality of binary values indicating whether a particular targeting attribute has been specified for a particular advertising campaign. The historical click-through data is modeled as a plurality of advertising campaign click-through binary vectors. The advertising campaign user attribute binary vectors comprise a plurality of binary values indicating whether a click corresponding to a particular advertising campaign came from a user with a particular user attribute. A plurality of Boltzmann machines corresponding to the advertising campaigns is formulated. The Boltzmann Machines are trained with the advertising campaign user attribute binary vectors and the advertiser-specified targeting attributes binary vectors. Using the trained Boltzmann Machines, a plurality of probability values corresponding to each element of each advertiser-specified targeting attributes binary vector is derived. For each advertising campaign, the targeting attributes are ranked based on the targeting attributes' corresponding probability values. In one embodiment, a probability threshold is determined, and at least one targeting attribute for each of the advertiser-specified targeting attributes binary vectors is selected as a recommended targeting attribute, wherein the probability value corresponding to the targeting attribute in a advertiser-specified targeting attributes binary vector is greater than the probability threshold.

According to an embodiment in which the machine learning model is a performance oriented model, a plurality of neighborhoods of advertising campaigns corresponding to the advertising campaigns is defined. A neighborhood comprises previous advertising campaigns that are similar to an advertising campaign. A plurality of local regression models is formulated using the neighborhoods of advertising campaigns. A plurality of advertising campaign vectors is derived using the local regression models, wherein each of the advertising campaigns vectors comprises a plurality of weights for each of a plurality of targeting attributes. For each advertising campaign, the targeting attributes are ranked based on their corresponding weights. In one embodiment, a threshold weight is determined, and for each advertising campaign vector, at least one targeting attribute whose corresponding weight exceeds the threshold weight value is selected as a recommended targeting attribute.

In any of the embodiments described herein, at least one explanation parameter may be generated from the recommended targeting attribute and the advertising campaigns, wherein the explanation parameter specifies reasons for a recommended targeting attribute. The explanation parameter is transmitted along with the recommended targeted attribute to the advertising entity.

### BRIEF DESCRIPTION OF THE DRAWINGS

FIG. 1 depicts a flowchart illustrating a procedure for delivering targeted attribute recommendations according to an embodiment.

FIG. 2A depicts a flowchart illustrating a collaborative filtering model for delivering targeted attribute recommendations incorporating matrix factorization according to an embodiment.

FIG. 2B depicts a flowchart illustrating a procedure for selecting targeting attributes according to an embodiment.

FIG. 3A depicts a flowchart illustrating a collaborative filtering model for delivering targeted attribute recommendations incorporating Boltzmann Machines according to an embodiment.

FIG. 3B depicts a flowchart illustrating a procedure for selecting targeting attributes according to an embodiment.

FIG. 4A depicts a flowchart illustrating a performance-based model for delivering targeted attribute recommendations incorporating a local regression according to an embodiment.

FIG. 4B depicts a flowchart illustrating a procedure for selecting targeting attributes according to an embodiment.

FIG. 5 depicts a diagram illustrating an advertisement delivery system within which some embodiments of the invention are implemented.

FIG. 6 depicts a diagram illustrating an advertisement delivery system within which some embodiments of the invention are implemented

FIG. 7 depicts a diagram illustrating an exemplary computing environment within which some embodiments of the invention operate.

FIG. 8 depicts a flowchart illustrating the operation of an advertising entity according to an embodiment.

FIG. 9 depicts a flowchart illustrating the operation of a content portal according to an embodiment.

FIG. 10 depicts a flowchart illustrating the operation of an advertising exchange entity as it interacts with an advertising entity according to an embodiment.

FIG. 11 depicts a flowchart illustrating the operation of an advertising exchange entity as it interacts with a content portal according to an embodiment.

FIG. 12 depicts a diagram illustrating an exemplary computing system for execution of the operations comprising various embodiments of the invention.

### DETAILED DESCRIPTION

In current Internet advertising systems, content portals and publishers offer advertising space on websites according to various user attributes. Through the use of cookies, browsing history, user profile information, or other data sources, a publisher or agent of a publisher may determine various attributes of a user requesting a webpage. For instance, the publisher may identify the user's gender, age, location, and interests by pairing a unique identifier provided by the user during a previous login process with information stored in the user's profile. To retrieve an advertisement suitable to present to the user, the publisher may provide the attributes of the user and the website along with a request for an advertisement to an advertisement exchange service.

Advertisers, in turn, seek to target an advertisement to users who are most likely to respond to the advertisement by clicking on it. For example, an advertisement for a restaurant in New York City is best presented to users who are located in New York City. In order to direct an advertising campaign to a particular demographic, advertisers use targeting attributes to define an audience of potentially receptive users. When submitting the advertisement to an advertising exchange service for placement on a webpage, an advertiser provides targeting attributes for the advertisement. The targeting attributes specify various criteria for the placement of the advertisement corresponding to types of users or webpage subject matter, e.g., the advertisement can only be presented to users of a certain age, gender, and location on a webpage of a particular type or content category. The advertising exchange service matches the advertisement to a webpage based on the targeting attributes provided by the advertiser and the user attributes provided by the publisher, along with other requirements specified by each (e.g., cost, size, frequency, etc). The transaction may be completed based on an auction, a revenue sharing agreement, or other conventions well known in the art.

Among the biggest challenges for the advertiser is selecting appropriate targeting attributes for the placement of advertisements. An advertiser may have multiple advertising campaigns with varying content and objectives. For each campaign, the advertiser seeks to maximize the likelihood of a user clicking on an advertisement and thereby ensure a high return on the investment of creating and placing the advertisement. Thus, the advertiser must meticulously select targeting attributes that result in the advertisement being presented to a user who is likely to have a high interest in the product, service, or brand being advertised. In doing so, the advertiser must understand the subtleties and nuances that distinguish different types of advertisements (e.g., brand awareness campaigns, product announcements, promotions, etc.) and how they influence optimal targeting criteria.

Many advertisers are unable to identify optimal targeting attributes for every advertising campaign. Performing the research necessary to identify targeting attributes that are most likely to result in a high response rate is a time- and labor-intensive endeavor that many advertisers cannot undertake. Furthermore, many advertisers lack access to the data necessary to conduct such an analysis. Although historical click-through data may provide advertisers with some guidelines for selecting targeting attributes, the continuously evolving nature of Internet usage trends coupled with a lack of expertise necessary to interpret such data limits its utility to advertisers. Thus, even the largest advertisers often select targeting attributes in a manner that amounts to guesswork.

In addition, the accuracy of the targeting attributes in predicting user response is crucial to the effectiveness of Internet advertising. Under-specified targeting attributes (i.e., broad criteria) may result in a large audience for the advertisement, but a smaller percentage of users who see the advertisement may actually be interested in it, resulting in a lower click through rate and a poor return on the advertiser's investment. Conversely, over-specified targeting attributes (i.e., narrow criteria) may result in a higher click-through rate but may exclude many users who would potentially be interested in the advertisement, diminishing its utility to the advertiser. Because of limited expertise or lack of access to data, it is often difficult for advertisers to achieve the optimal balance between under-specification and over-specification of targeting attributes for advertising campaigns.

Internet content portals, publishers, ad networks, advertising exchange services, and other agents with direct access to click-through data and historical targeting attribute selections are better positioned to make informed targeting attribute recommendations to advertisers. The present invention addresses the difficulty of specifying optimal targeting attributes by providing a novel system and method for automatically recommending targeting attributes for an advertising campaign. Through the use of a machine-learning model that processes historical click-through data or targeting attributes specified for similar advertising campaigns, the present invention overcomes the inherent uncertainty of targeting attributes that are exclusively advertiser-specified.

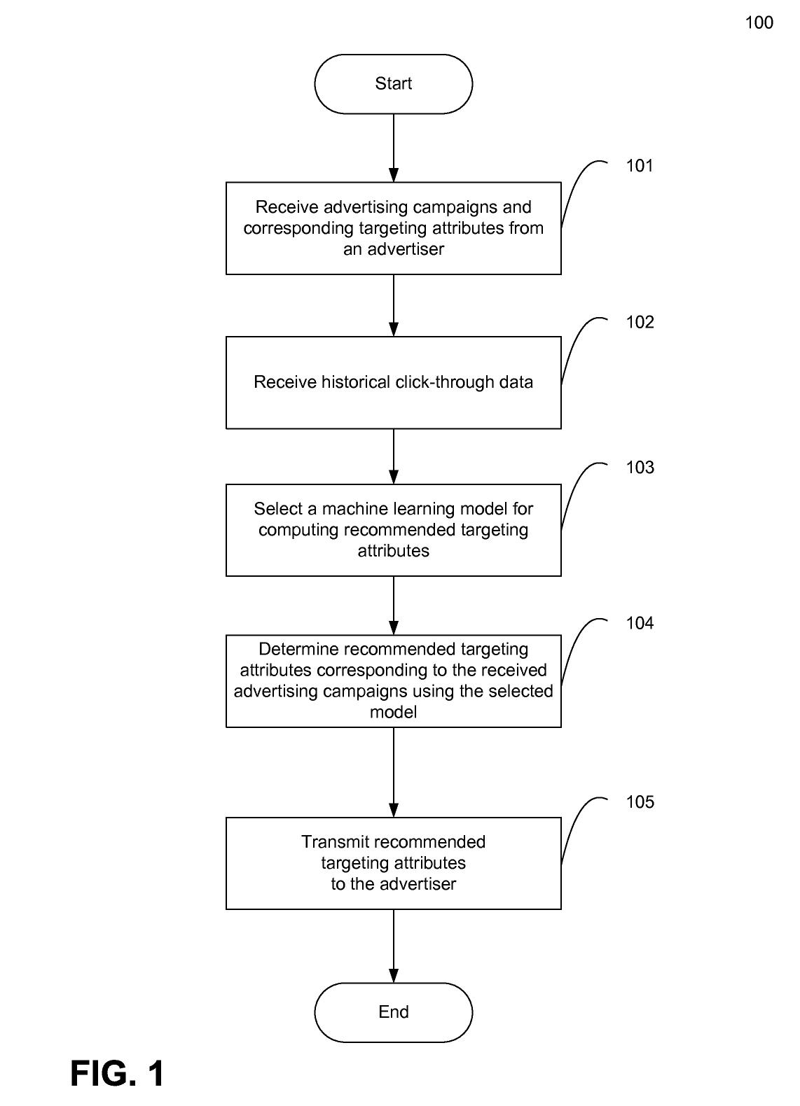

A flow diagram 100 illustrating the operation of present invention is depicted in FIG. 1. At operation 101, a series of advertising campaigns and corresponding targeting attributes are received from an advertiser. The targeting attributes represent various advertiser-specified criteria, such as user demographic criteria (e.g., age, gender, location, etc.) and/or webpage content criteria (e.g. webpages relating to a particular subject), for the placement of advertisements associated with the advertising campaign. At operation 102, historical click-through data is received. In one embodiment, the historical click-through data comprises performance data of previous advertising campaigns. The click-through data may include information about the previous advertising campaigns and the user attributes of viewers who selected an advertisement associated with the campaign. At operation 103, a machine learning model for computing recommended targeting attributes is selected. The model may be a collaborative filtering model or a performance-based model (see below). At operation 103, recommended targeting attributes corresponding to the series of advertising campaigns received at operation 101 are determined using the selected model. The recommended targeting attributes are transmitted to the advertiser at step 104 and the procedure concludes.

According to the present invention, the procedure of operation 103 may be implemented using one of two machine-learning models: a collaborative filtering model and a performance-based model.

### Collaborative Filtering Model

One series of embodiments of the present invention relies on a collaborative filtering model to interpret targeting and click-through data to provide more accurate targeting attribute recommendations. In a collaborative filtering model, known sources of information are aggregated and filtered in order to discover patterns pertaining to latent factors, i.e., unobservable characteristics that explain similarity or congruence between two data points. In the present embodiments, the latent factors are the characteristics of one or more advertising campaigns that make them appeal to users representing particular targeting attributes. This approach assumes that the targeting attributes specified by the advertiser are correct, but incomplete, and the aim of the collaborative filtering model is to identify recommended targeting attributes to augment the advertiser-specified targeting attributes.

In one such embodiment, the entire set of advertising campaigns and their corresponding advertiser-specified targeting attributes are modeled as an n×m matrix of binary values R, where n is the number of advertising campaigns and m is the number of targeting attributes:

Rε[0,1]^{n×m}

Thus, each row rᵢ of R is a binary vector wherein rᵢₖ=1 indicates that the advertiser has specified targeting attribute k for advertising campaign i. Similarly, click-through data of prior advertising campaigns is modeled as an n×k matrix U, where n is the number of ad campaigns and k is the number of unique user attributes:

UεR^{n×k}

A user attribute is analogous to a targeting attribute, but specifies an attribute of a user or a website that resulted in an advertisement being clicked. Thus, each row uᵢ of U is a vector wherein the value of uᵢₖ indicates the frequency that clicks corresponding to advertising campaign i came from users or webpages with user attribute k.

In this embodiment, the recommended targeting attributes are determined by factorizing R into lower-dimensional matrices P and Q, where P is a subset of U and Q maps user attributes k to targeting attributes m. Thus:

\tilde{R}=PQ, PεR^{n×k}, and QεR^{k×m}

The objective of this factorization is to discover, for each advertising campaign received from the advertiser, at least one similar advertising campaign in the historical click-through data. The similar advertising campaign can be discerned by determining which previous advertising campaigns achieved frequent clicks for user attributes equivalent to the targeting attributes specified by the advertiser for a given advertising campaign. Once the similar previous advertising campaign has been determined, the recommended targeting attributes can be identified as those whose analogous user attributes resulted in frequent clicks for the similar advertising campaign but which were not specified by the advertiser. This is because the previous advertising campaign and the advertising campaign received from the advertiser share the same latent factors. If the advertiser-specified targeting attributes of a current advertising campaign are a subset of the user attributes that resulted in frequent clicks for a previous advertising campaign, the particular advertising campaign can be expected to achieve similar results for the same targeting attributes. Thus, the recommended targeting attributes are the remaining user attributes that are not in the subset. By reconstructing R as a dot product of matrices P and Q that comprise historical targeting data for previous advertising campaigns, we can capture these “missing” values.

To achieve an optimal realization of this objective, the factorization of R into P and Q is performed based on a number of criteria. Firstly, there is a need to ensure consistency with existing targeting attributes. The reconstructed matrix \tilde{R}=PQ should accurately reproduce the existing targeting attributes. Thus, any discrepancy between R and PQ must be minimized. To measure this discrepancy, Frobenius-2 norm is used:

∥R−PQ∥_{F}²

Secondly, in order for a current advertising campaign and a historical advertising campaign to be regarded as similar, there must be consistency between the current campaign's advertiser-specified targeting attributes and the previous campaign's most frequent user attributes. If two advertising campaigns i and j are highly similar as indicated by their attribute vectors uᵢ and uⱼ, their latent factors can be expected to be similar too. To ensure that only advertising campaigns with a substantial overlap between user attributes and targeting attributes are paired, we use the following factorization technique:

$$tr ( {P}^{T} LP ) = {\sum }_{i = 1}^{n} {\sum }_{j = 1}^{n} {S}_{ij} ( {\sum }_{z} {( {P}_{iz} - {P}_{jz} )}^{2} )$$

where S is a similarity matrix. Sᵢⱼ is a value indicating the similarity between advertising campaigns i and j computed from the targeting attributes vectors uᵢ and uⱼ using similarity measures well-known in the art like cosine similarity or Pearson correlation. L is the graph Laplacian matrix calculated from the similarity matrix S as:

L=D−S

where

$${D}_{ij} = {\sum }_{k = 1}^{n} {S}_{ik}$$

if i=j, and 0 otherwise.

Thirdly, similar latent factors must be kept sparse to avoid overfitting; in other words, the algorithm must be designed to avoid grouping too many advertising campaigns and thereby recommending too many targeting attributes. Thus, each of the matrices P and Q are regularized individually:

∥P|_{F}²+|Q|_{F}²

Aggregating these three criteria results in the following optimization algorithm:

$${min}_{P ∈ {R}^{n \times k} , Q ∈ {R}^{k \times m}} {‖ R - PQ ‖}_{F}^{2} + α tr ( {P}^{T} LP ) + β ( {‖ P ‖}_{F}^{2} + {‖ Q ‖}_{F}^{2} )$$

To solve P and Q, a function ƒ(P,Q) is defined as:

ƒ(P,Q)=∥R−PQ∥_{F}²+αtr(P^{T}LP)+β(∥P∥_{F}²+∥Q∥_{F}²)

ƒ(P,Q)=tr((R−PQ)^{T}(R−PQ)+α·P^{T}LP+β(PP^{T}+QQ^{T}))

There are two techniques for solving P and Q known in the art: stochastic gradient descent and alternating least squares. The stochastic gradient descent technique updates P and Q by modifying them by a magnitude proportional to the opposite direction of the gradient. The alternating least squares technique holds one parameter constant and optimizes the other iteratively until both parameters converge. The alternating least squares technique has the advantage of easier implementation and faster computational speed by facilitating the use of parallel computation. Although the alternating least squares technique is demonstrated here, the stochastic gradient technique or other equivalent procedures may be used without deviating from the scope and spirit of the invention.

Thus, Q is held constant and the derivative of ƒ(P,Q) is taken with respect to P:

$$\frac{\partial f}{\partial P} = - 2 {RQ}^{T} + 2 {PQQ}^{T} + 2 α LP + 2 β P$$

By setting the derivative to zero, the equation becomes:

PQQ^{T}+(αL+βI)P=RQ

This equation can be solved using the Lyapunov equation:

AX+XB=C

The values of X are given by:

vec(X)=(I [symbol] A+B^{T} [symbol] I)⁻¹vec(C)

wherein [symbol] denotes the Kronecker product and vec(X) denotes the vectorization operation of a matrix X, which is a linear transformation that converts the matrix into a column vector. The values of Q can be similarly derived by holding P constant.

After computing the matrices P and Q, the recommended targeting attributes for an advertising campaign can be identified as those that correspond to high values within the matrix P—paired with the matrix Q that specifies the mapping between user attributes and target attributes—that were not specified by the advertiser for the advertising campaign. For each advertising campaign, the targeting attributes are ranked based on their corresponding values in the matrix P. In one embodiment, a threshold is determined, and the recommended targeting attributes are identified as those whose corresponding values in the matrix P exceed the determined threshold.

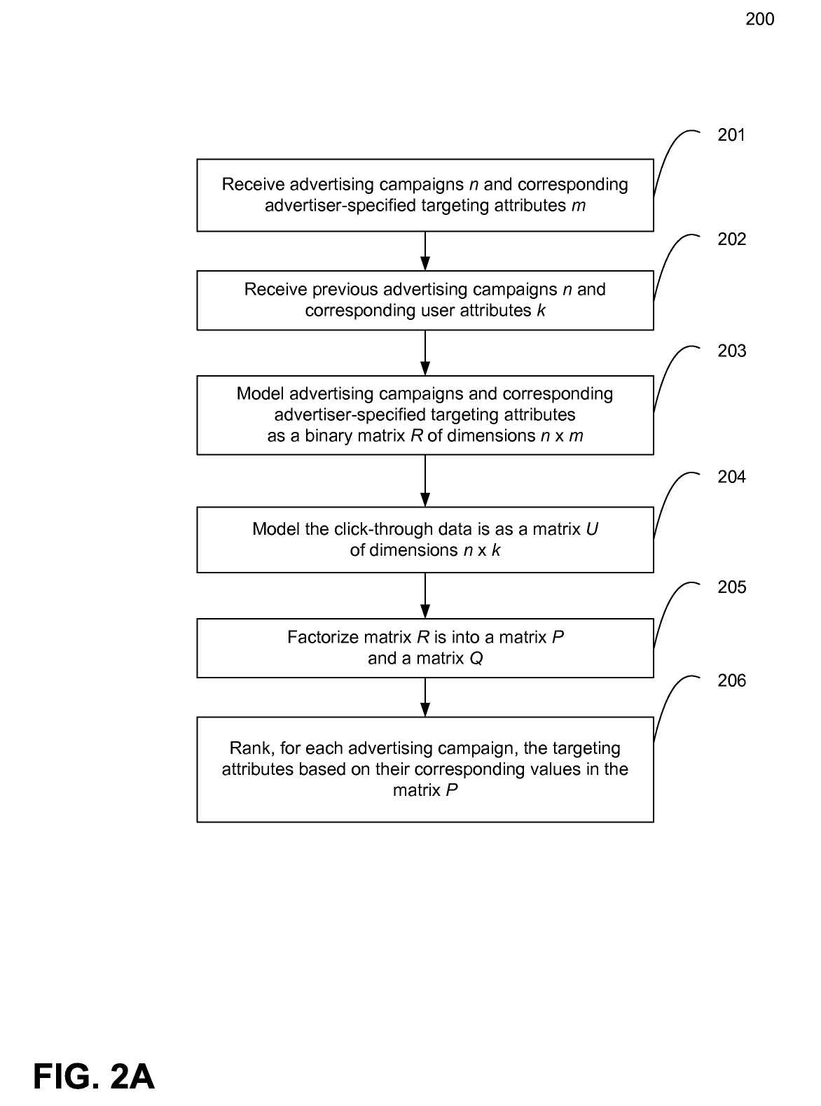

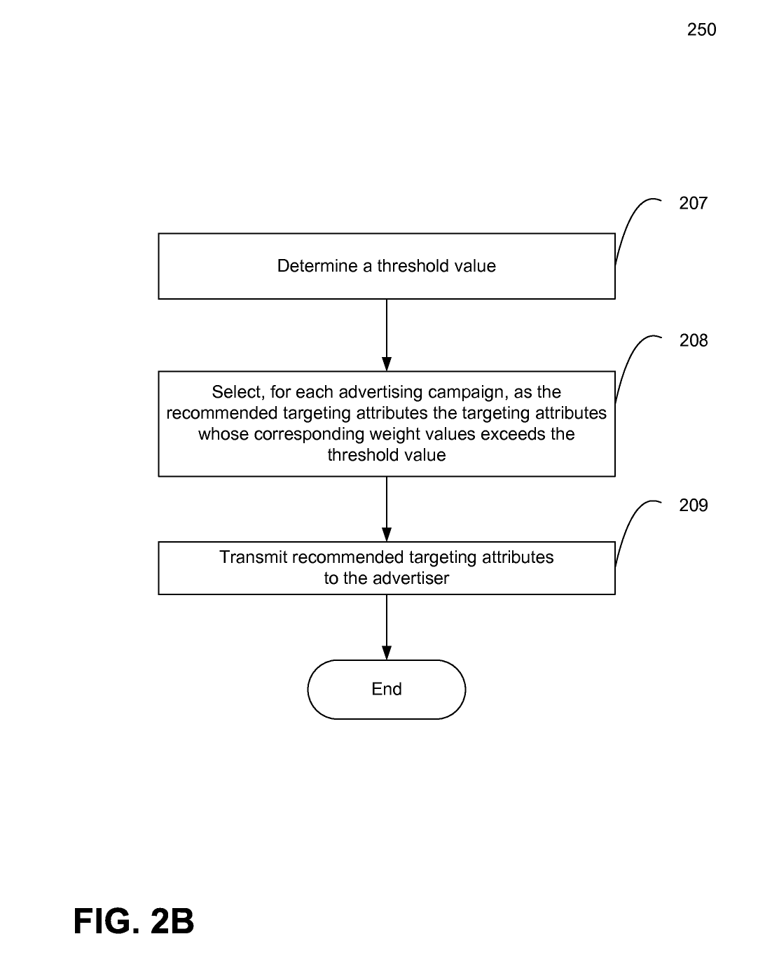

This embodiment is illustrated in the flowchart depicted in FIG. 2A, which corresponds to operations 101-104 of FIG. 1 in which the selected machine-learning model is a collaborative filtering model. At step 201, a number of advertising campaigns n and a number of corresponding advertiser-specified targeting attributes m are received. At step 202, click-through data comprising a number of previous advertising campaigns n and a number of corresponding user attributes k are received. At step 203, the set of advertising campaigns and corresponding advertiser-specified targeting attributes is modeled as a binary matrix R of dimensions n×m. At step 204, the click-through data is modeled as a matrix U of dimensions n×k. At step 205, the matrix R is factorized into a matrix P and a matrix Q, wherein P is a subset of U and Q maps user attributes to targeting attributes. At step 206, for each advertising campaign, the targeting attributes are ranked based on their corresponding values in the matrix P.

An alternate embodiment is illustrated in the flowchart 250 depicted in FIG. 2B, which corresponds to operations 104-105 of FIG. 1. At step 207, a threshold value is determined. At step 208, for each advertising campaign, the targeting attributes whose corresponding weight values exceeds the threshold value are selected as the recommended targeting attributes. At operation 209, the recommended targeting attributes are transmitted to the advertiser and the procedure concludes.

Another such embodiment relies on a concept known as a Boltzmann Machine. A Boltzmann Machine is a network of symmetrically connected, neuron-like, binary state units that can be trained to make stochastic decisions on whether to take on a particular state. After training, the units of a Boltzmann Machine will take on values that have a high probability of replicating the training data. In this embodiment, a simplified Boltzmann Machine known as a Restricted Boltzmann Machine (RBM) is used. A restricted Boltzmann Machine comprises a layer of visible units and a layer of hidden units without any intra-layer connections.

According to the present embodiment, the parameters of an RBM are functions of the user attributes of a particular previous advertising campaign. Each advertising campaign's user attributes are modeled as a binary vector. Thus, each advertising campaign has a unique RBM incorporating contextual information, a concept referred to herein as a Contextual Restricted Boltzmann Machine (CRBM). Unlike an RBM, a CRBM is able to adapt to a specific context by tuning its parameters and, in the present implementation, provide more accurate recommendations. The learning of a CRBM follows that of an RBM, but the user attribute vectors are incorporated in the gradient ascend updating.

A Boltzmann Machines is a special form of a log-linear Markov Random Field (MRF) in which the energy function is linear in its free parameters. The global energy E in a Boltzmann Machine is represented by:

$$E = - {\sum }_{i < j} {w}_{ij} {s}_{i} {s}_{j} + {\sum }_{i} {b}_{i} {s}_{i}$$

where wᵢⱼ is the weight of the connection between i and j, sᵢε{0,1} is the state of i, and bᵢ is the bias of unit i. There are no self-connections in a Boltzmann Machine, and each connection is symmetric (wᵢⱼ=wⱼᵢ).

In a Boltzmann Machine, the probability that unit i occupies an “on” state follows the logistic function:

$$P ( {s}_{i} = 1 ) = \frac{1}{1 + {e}^{- {z}_{i}}}$$

where zᵢ is the total input of unit i:

$${z}_{i} = {b}_{i} - {\sum }_{j} {w}_{ij} {s}_{j}$$

A Boltzmann Machine reaches its equilibrium after sequentially updating the units in any order that does not depend on their total inputs. Specifically, the probability of a state vector v is determined by its energy relative to the energies of all possible binary states:

$$P ( v ) = \frac{{e}^{- E ( v )}}{{\sum }_{u} {e}^{- E ( u )}}$$

In an RBM, due to the lack of connections between layers of visible units and layers of hidden units, the hidden units are conditionally independent given a visible vector.

In this implementation of the present embodiment, the known information is the set of advertiser-specified targeting attributes and the historical click-through data. Although the user attribute information provided by the historical click-through data is noisy, it provides valuable side information about the advertising campaigns that can help guide the collaborative filtering process. The parameters of the RBM are modeled to be dependent on this side information, resulting in the CRBM of the present embodiment.

The parameters wᵢⱼ and θᵢ in the CRBM are not static; rather, they vary for each advertising campaign. A linear function is used to model each of the dependencies:

wᵢⱼ=Wᵢⱼ^{T}u

bᵢⱼ=bᵢⱼ^{T}u

As noted above, the learning of a CRBM essentially follows that of an RBM using contrastive divergence. Specifically:

$$\frac{\partial E ( v )}{\partial {w}_{ij}} = - {s}_{i}^{v} {s}_{j}^{v} {u}^{v} and {〈 \frac{\partial log P ( v )}{\partial {w}_{ij}} 〉}_{data} = {〈 {s}_{i} {s}_{j} u 〉}_{data} - {〈 {s}_{i} {s}_{j} u 〉}_{model}$$

where [symbol] [symbol] _{data} is the expected value in the data distribution and [symbol] [symbol] _{model} is the expected value when the Boltzmann machine is sampling state vectors from its equilibrium distribution.

To perform a gradient ascent on the log probability that the Boltzmann Machine generates the observed data when sampling from its equilibrium distribution, wᵢⱼ is incremented by a small learning rate times the right hand side of the above equation. The learning rule for the bias parameter bᵢ follows a similar procedure.

After training the model, each CRBM will yield a probability value corresponding to the likelihood of a 1 result in each element of the binary vector. This probability value represents the strength of a targeting attribute. For each advertising campaign, the targeting attributes are ranked based on these probability values. In one embodiment, a threshold probability value is determined, and the attributes corresponding to elements of the binary vector whose probability value exceeds the threshold probability value are selected as the recommended targeting attributes.

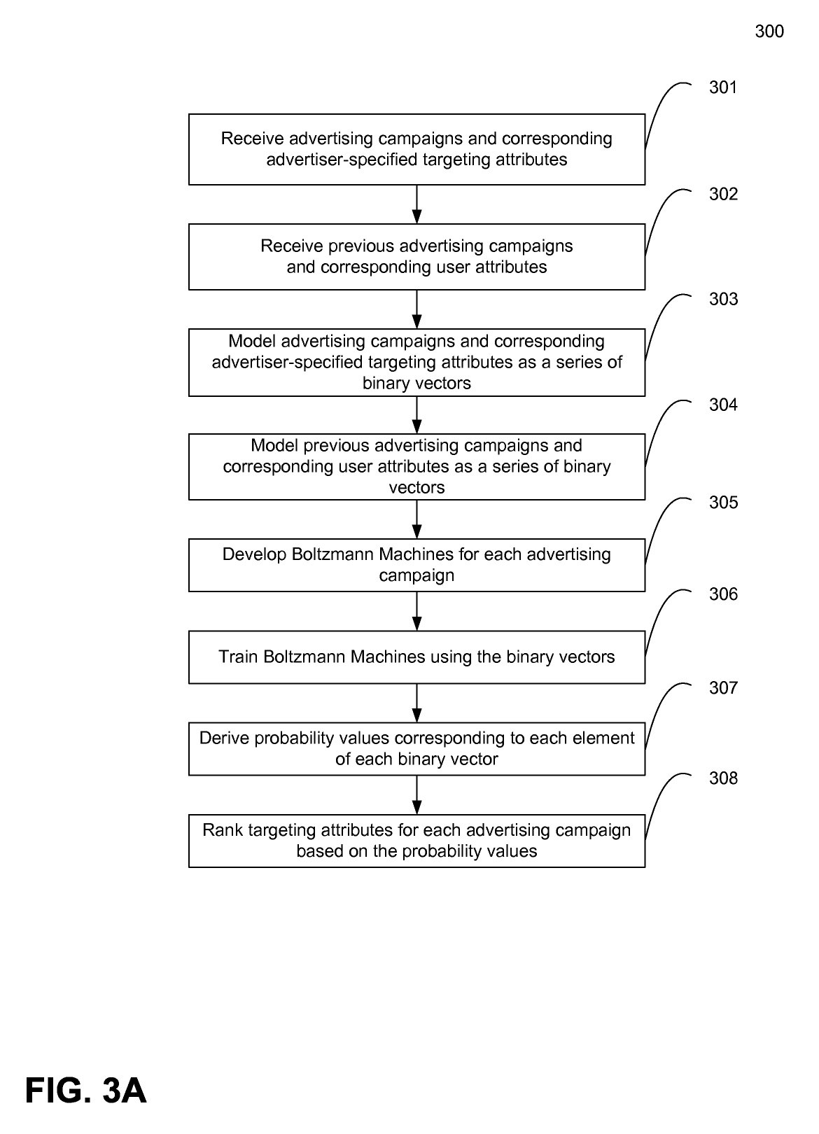

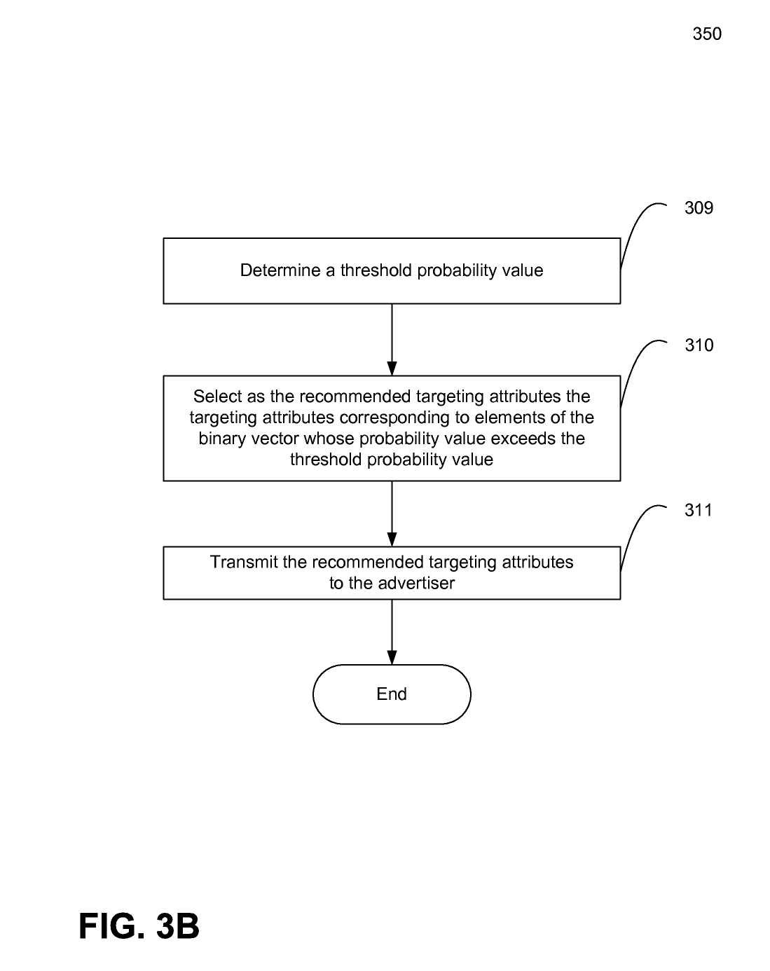

This embodiment is illustrated in the flowchart depicted in FIG. 3, which corresponds to operations 101-104 of FIG. 1 in the selected machine-learning model is a collaborative filtering model. At step 301, a set of advertising campaigns and corresponding advertiser-specified targeting attributes are received. At step 302, a set of previous advertising campaigns and corresponding user attributes are received. At step 303, the set of advertising campaigns and corresponding advertiser-specified targeting attributes is modeled as a series of binary vectors. At step 304, the set of previous advertising campaigns and corresponding user attributes is modeled as a series of binary vectors. At step 305, Boltzmann Machines are developed for each advertising campaign. At step 306, the Boltzmann Machines are trained using the binary vectors. At step 307, a series of probability values corresponding to each element of each binary vector are derived. At step 308, for each advertising campaign, the targeting attributes are ranked based on these probability values.

An alternate embodiment is illustrated the flowchart 350 depicted in FIG. 3B, which corresponds to steps 104-105 of FIG. 1. At step 309, a threshold probability value is determined. At step 310, the targeting attributes corresponding to elements of the binary vector whose probability value exceeds the threshold probability value are selected as the recommended targeting attributes. At step 311, the recommended targeting attributes are transmitted to the advertiser and the procedure concludes.

### Performance-Based Model

In an alternative series of embodiments, a performance-oriented model is used. In this series of embodiments, an algorithm is developed to determine, using historical data, which targeting attributes have the greatest impact on improving the performance of a similar previous advertising campaign. Performance can be measured in terms of any metric ordinarily used in the art, such as click-through rate (CTR) or return on investment (ROI). In the embodiments illustrated herein, CTR has been used. However, other metrics may be used without deviating from the scope or spirit of the invention.

In one such embodiment, a “neighborhood” of advertising campaigns N(i) is defined, where N(i) represents a set of previous advertising campaigns taken from the historical targeting data similar to advertising campaign i. Similarity may be evaluated based on the user attributes of a previous advertising campaign using similarity measures such as the Pearson correlation, which are well-known in the art. In this embodiment, the aim of the algorithm is to determine the effect of each targeting attribute on the click-through rate for an advertising campaign j, wherein j is an element of N(i). These weights are represented as a vector w. A local regression is used to model this relationship:

$${min}_{w ∈ {R}^{m}} {\sum }_{j ∈ N ( i )} {( {c}_{j} - {w}^{T} {t}_{j} )}^{2}$$

In the above equation, cⱼ represents the click-through rate of line item j. Each element wⱼ is a value indicating an attribute's effect on the click-through rate of advertising campaign j.

To select recommended targeting attributes from among the attributes of advertising campaigns N(i), the above model must be regularized to account for a number of criteria. Among these is diversity. Each targeting attribute consists of a targeting type and a targeting entity. A targeting type describes the characteristic that a targeting attribute pertains to, e.g., age, gender, publisher, etc. A targeting entity is the data item that the targeting type describes, e.g., 20-25, male, yahoo! mail, etc. Targeting attributes may be categorized by their targeting types such that all of the attributes in each category are of the same type. Thus, the set of targeting attributes can be modeled as G₁, G₂, . . . , G_{z}, where z is the number of unique targeting types. The local regression algorithm must be regularized to ensure that the recommended targeting attributes are drawn from a variety of types instead of being clustered around one or two types. To achieve this, a grouped regularization known in the art as exclusive lasso is used:

$${\sum }_{j = 1}^{z} {{a}_{j} ( {\sum }_{k ∈ {G}_{j}} \vert {w}_{k} \vert )}^{2 } \leq d$$

The above equation is an exclusive lasso regularizer in which the I₁ norm is used to combine the weights of attributes in the same group, the I₂ norm is used to combine the weights of different groups, and aⱼ is used to balance the size of group Gⱼ. The exclusive lasso regularizer has been theoretically and empirically proven to introduce competitiveness within a multivariable group and thus generate sparse solutions[6]. In the current embodiment, competitiveness is desired among the targeting attributes in each group; thus, only those attributes with a significant impact on click-through rate will have a non-zero weight wₖ

A further optimization, which borrows from the collaborative filtering approach described above, involves selecting popular targeting attributes from the neighborhood N(i). Because the advertising campaigns of N(i) have been determined to be similar enough to i to define a neighborhood, the popular targeting attributes found in i's neighborhood are likely to be shared by i. Popular targeting attributes may be determined by noting the frequency of certain user attributes in the historical click-through data. Thus, the exclusive lasso regularization is modified to incorporate these popular targeting attributes:

$${\sum }_{j = 1}^{z} {{a}_{j} ( {\sum }_{k ∈ {G}_{j}} \vert \frac{{w}_{k}}{{f}_{k}} \vert )}^{2} \leq d$$

In the above equation,

$${f}_{k} = {\sum }_{j ∈ N ( i )} {r}_{jk}$$

represents the frequency of attribute k in the neighborhood N(i). Each attribute in the neighborhood N(i) is penalized by a magnitude inversely proportional to its popularity in the neighborhood. Thus, if attribute k is popular, the function ƒₖ yields a large value; k is penalized less and is thus more likely to be selected.

Incorporating these constraints into the local regression model yields:

$${min}_{w ∈ {R}_{+}^{m} } {\sum }_{j ∈ N ( i )} {( {c}_{j} - {w}^{T} {t}_{j} )}^{2} such that {\sum }_{j = 1}^{z} {{a}_{j} ( {\sum }_{k ∈ {G}_{j}} \vert \frac{{w}_{k}}{{f}_{k}} \vert )}^{2} \leq d ,$$

which is equivalent to:

$${min}_{w ∈ {R}_{+}^{m}} {\sum }_{j ∈ N ( i )} {( {c}_{j} - {w}^{T} {t}_{j} )}^{2} + λ {\sum }_{j = 1}^{z} {{a}_{j} ( {\sum }_{k ∈ {G}_{j}} \vert \frac{{w}_{k}}{{f}_{k}} \vert )}^{2}$$

This optimization problem, which can be solved using a quadratic programming (QP) model or similar techniques well-known in the art, yields a vector w for each advertising campaign, the length of which is equivalent to the number of unique targeting attributes. The zero values of w correspond to targeting attributes that have been filtered out and should not be recommended, leaving the non-zero values as potential recommended targeting attributes. For each advertising campaign, the targeting attributes corresponding to non-zero values in the vector w are ranked based on these values. In one embodiment, a threshold value is determined, and only those targeting attributes whose corresponding values exceed the threshold value are selected as recommended targeting attributes.

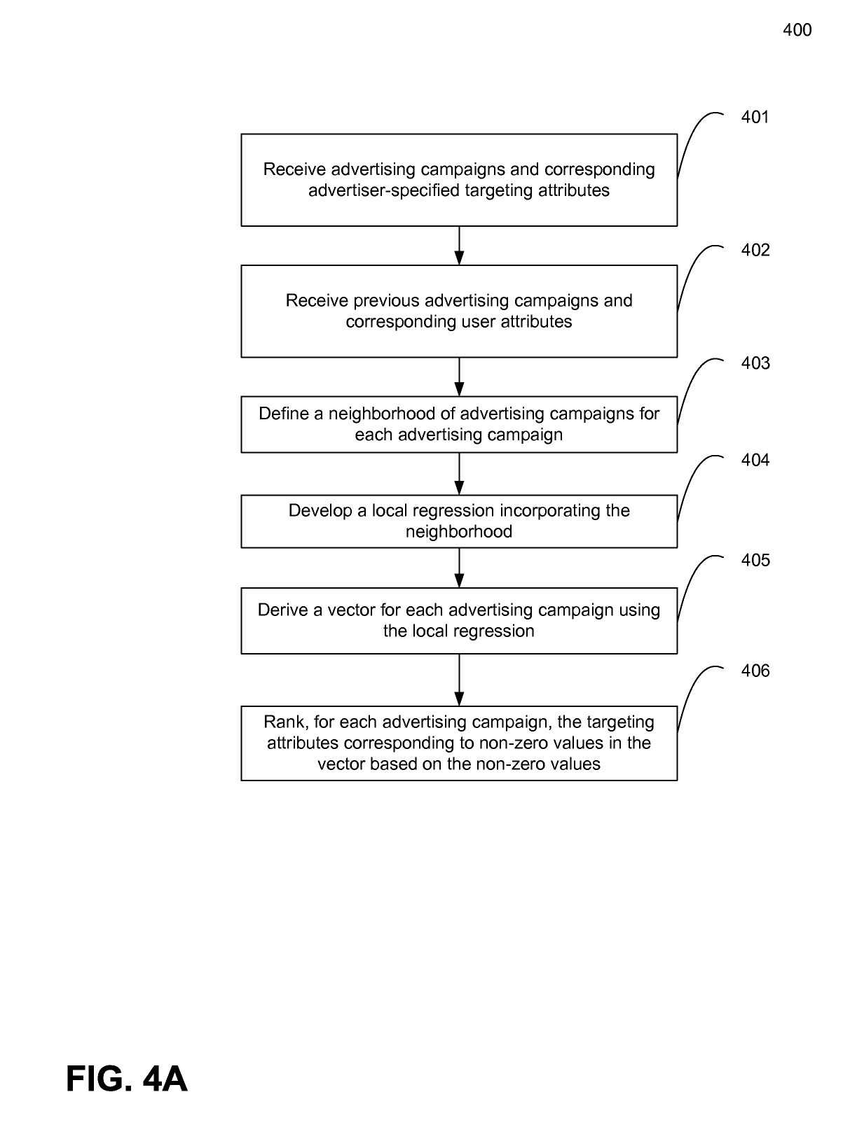

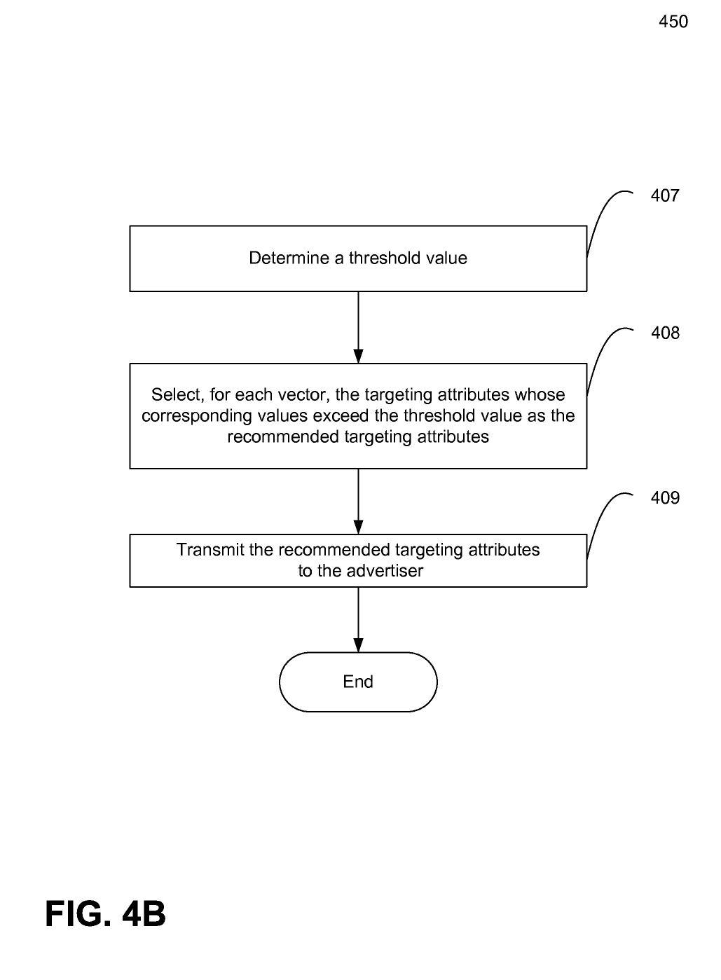

This embodiment is illustrated in the flowchart depicted in FIG. 4A, which corresponds to operations 101-103 of FIG. 1 in which the selected machine-learning model is a performance-oriented model. At step 401, a set of advertising campaigns and corresponding advertiser-specified targeting attributes are received. At step 402, a set of previous advertising campaigns and corresponding user attributes are received. At step 403, a neighborhood of advertising campaigns is defined for each advertising campaign, wherein the neighborhood comprises previous advertising campaigns that are similar to a received advertising campaign. At step 404, a local regression incorporating the neighborhood is developed. At step 405, a vector for each advertising campaign is derived using the local regression. At step 406, for each advertising campaign, the targeting attributes corresponding to non-zero values in the vector are ranked based on these values.

An alternate embodiment is illustrated in the flowchart 450 depicted in FIG. 4B, which corresponds to steps 104-105 of FIG. 1. At step 407, a threshold value is determined. At step 408, for each vector, the targeting attributes whose corresponding values exceed the threshold value are selected as recommended targeting attributes for the corresponding advertising campaign. At step 409, the recommended targeting attributes are transmitted to the advertiser and the procedure concludes.

The embodiments described herein may be implemented as part of an advertising exchange service. An advertising exchange service typically integrates entities, such as advertisers and publishers. An advertising exchange service typically operates in conjunction with advertisers and publishers in order to deliver ads, from one or more advertisers, to Web pages of one or more publishers. For example, Yahoo! Inc, the assignee of the present invention, operates such an advertising exchange service.

An integrator network entity generally defines a participant of the advertising exchange system that represents or integrates one or more entities on the advertising exchange system (e.g., advertisers, publishers, advertising networks, etc.). For example, an integrator network may represent advertisers on the advertising exchange system in order to deliver advertisements to publishers, advertising networks and other integrator networks. In some embodiments, the integrator networks are referred to as the “users” of the advertising exchange system. The integrated networks may comprise third party agents that operate on behalf of or are part of the integrator network. The term “third party agent” is used to generally describe an agent or customer that participates in transactions on the advertising exchange system. Similarly, the term “third party recipient” is used to describe a user or participant of the advertising exchange system that receives information from the system, such as bid requests. However, the terms integrator networks, third party agents and third party recipients is intended to represent a broad class of entities, including publishers, advertisers and networks, as well as the agents that represent them, that operate on the advertising exchange system.

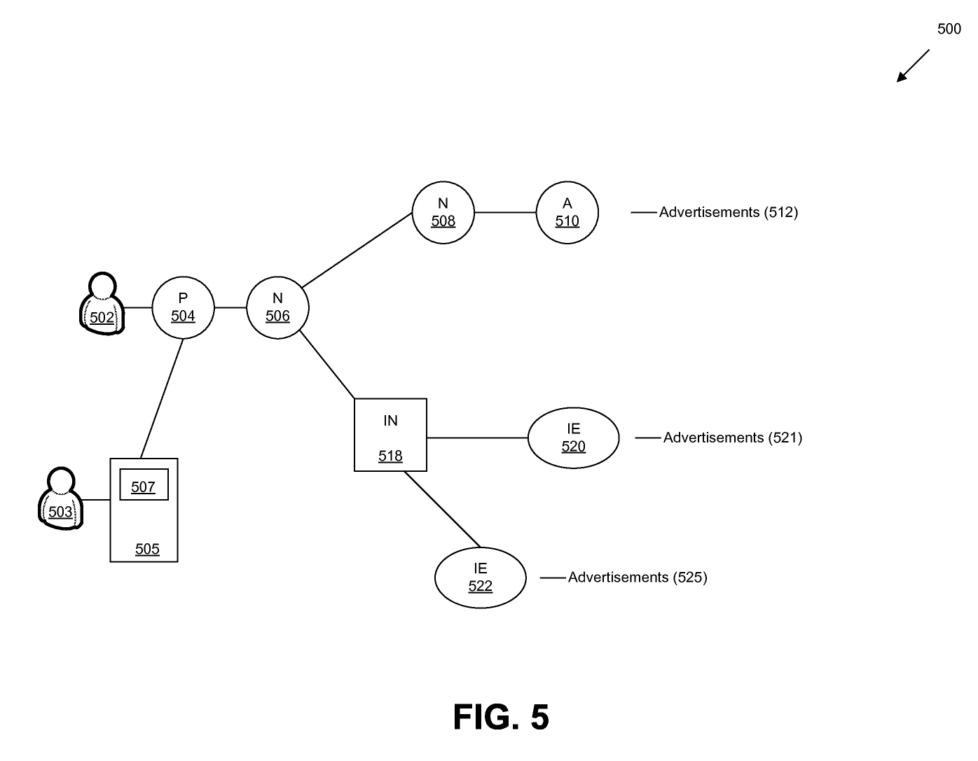

FIG. 5 illustrates one embodiment of an ad delivery system. As shown in FIG. 5, the system 500 includes a variety of entities such as users 502 and 503, one or more publishers 504, networks 506 and 508, and/or advertisers 510. The system 500 further includes one or more integrator networks (IN) 518 that have one or more integrated entities (IE) 520 and 522. The various entities including users, publishers, networks, advertisers, integrator networks and integrated entities illustrated in FIG. 5 are merely exemplary, and one of ordinary skill recognizes that the system 500 may include large numbers of entities. Moreover, the various entities are coupled together in different advantageous configurations such as, for example, the exemplary configuration illustrated in FIG. 5.

The user 503 accesses information and/or content provided by the publisher 504. One form of access may include a browser 505 that has inventory locations 507 for the presentation of advertising. In one embodiment, an ad call is generated that requests an advertisement, from advertisements 512, 520 and 121, for placement with the inventory location 507. The corresponding advertisement may be delivered to publisher 504 by one or more networks. For instance, in one example, the network 506 is coupled to the publisher 504, and the network 508 is coupled to the advertiser 510. For this example, the networks 506 and 508 are coupled to each other. The advertiser 510 generally has one or more ad campaigns each comprising one or more advertisements 512 that the advertiser 510 wishes to place with the inventory of publishers such as, for example, the inventory location 507 of the publisher 504 that is presented to the user 503 via the browser application 505.

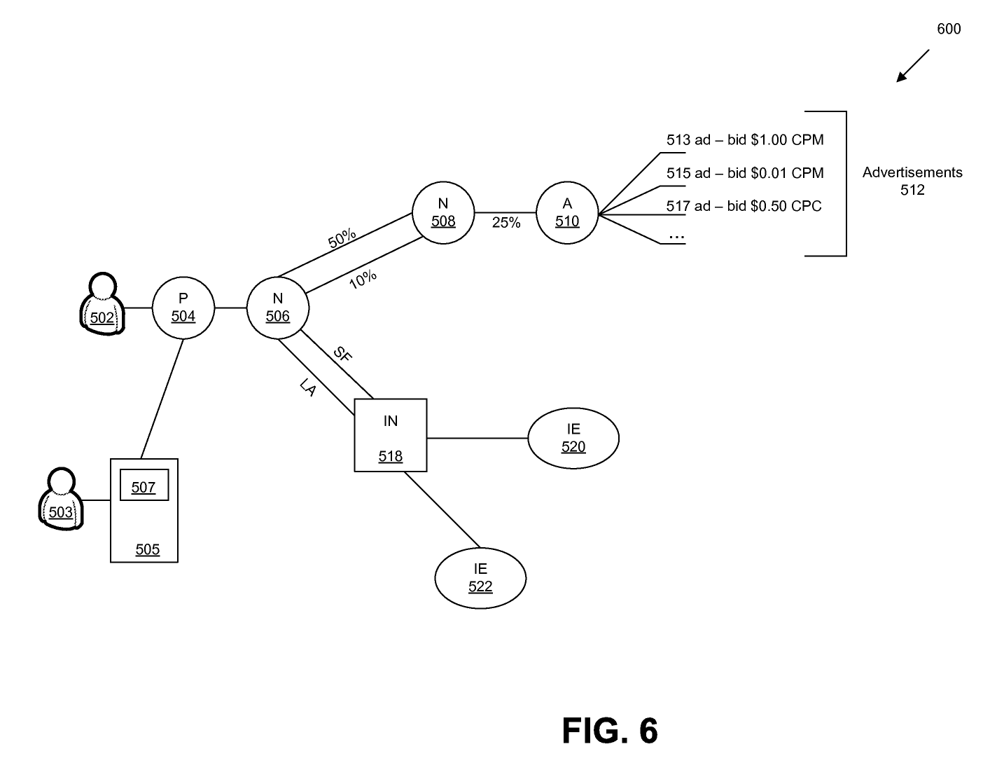

FIG. 6 illustrates another embodiment of an ad delivery system. For this example, the advertisements 513, 515, and 517 generally each have an associated bid that the advertiser 510 will pay for the placement of the advertisement with the inventory and for presentation to the user(s). For this example, the advertisement 513 has a bid of $1.00 cost per thousand page impressions (“CPM”), the advertisement 515 has a bid of $0.01 CPM, and the advertisement 516 has a bid of $0.50 cost per click (“CPC”). One of ordinary skill recognizes different types of bids such as, for example, CPM, CPC, cost per action (“CPA”), and others. Some systems normalize the ad bids to CPM.

For the example illustrated in FIG. 6, the entities along the chain of distribution for the advertisements have various revenue sharing agreements. In this example, the network 508 has a 25% revenue sharing agreement with the network 506 for fees paid by the advertiser 510. Similarly, the network 506 has 50% and 10% revenue sharing agreements with the publisher 504 for fees paid to the network 506 by way of the network 508. The multiple revenue sharing agreements between entities may be for different campaigns and/or for targeting different segments of users. For example, the 50% revenue sharing agreement between networks 508 and 506 may be used to target a user segment that includes males under 40 years old, who have an interest in sports. In another example illustrated in FIG. 2, the 10% revenue sharing agreement may be used to target females, over 30 years old, who have an interest in gardening. For these examples, network 508 delivers users of the target segment to network 506, and network 506 is the exclusive representative of the publisher 504. One of ordinary skill recognizes many different payment and/or targeting schemes.

Alternatively, and/or in conjunction with the embodiments described above, some embodiments direct an ad call for the inventory 507 to an integrator network 518. In one example, the ad call is passed from the network 506 to the integrator network 118 with additional information such as, for example, a geographic location for the destination of the advertisement. In the illustration of FIG. 2, one ad call may have a destination of San Francisco (SF), while another ad call may have a destination of Los Angeles (LA). Based on the ad call and/or information, the integrator network 518 selectively responds to ad calls for, or on behalf of, one or more of its integrated entities 520 and/or 522. The integrated entities 520 and 522 generally include third party entities, such as advertisers, that transact on the exchange by using an intermediary, such as the integrator network 518.

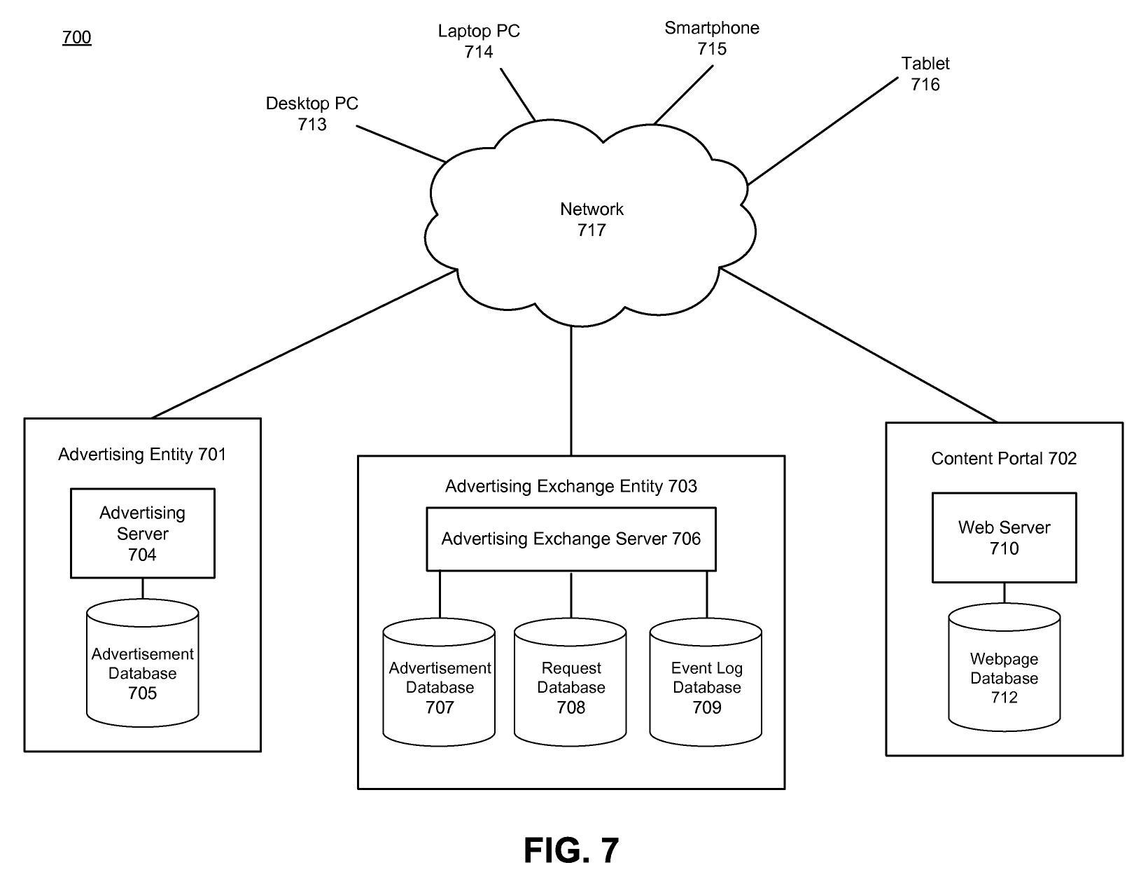

An exemplary environment within which some embodiments of the invention may operate is illustrated in FIG. 7. The diagram of FIG. 7 depicts an advertising entity 701, a content portal 702, an advertising exchange entity 703, and client devices 713-716. The advertising entity 701 is a provider of products or services who seeks to place an advertisement within a webpage of the content portal 703. The advertising entity 701 includes an advertising server 704 and an advertisement database 705. The content portal 702 is a publisher or other provider of online content that seeks advertisements from advertising entity 701. The content portal 702 includes a web server 710 and a webpage database 712. The advertising exchange entity 703 matches requests for advertisements received from the content portal 702 with advertisements received from the advertising entity 701. The advertising exchange entity 703 includes an advertising exchange server 706, an advertisement database 707, a request database 708, and an event log database 709. According to one embodiment, the advertising exchange entity 703 may be affiliated with and/or operated by the content portal 702. In this embodiment, there may be a direct connection (not pictured) between the advertising exchange entity 703 and the content portal 702. The client devices may include a desktop PC 713, a laptop PC 714, a smartphone 715, a tablet PC 716, or any other device capable of displaying a web page. All communication between and among athen advertising entity 701, the content portal 702, the advertising exchange entity 703, and the client devices 713-716 occurs over the network 717.

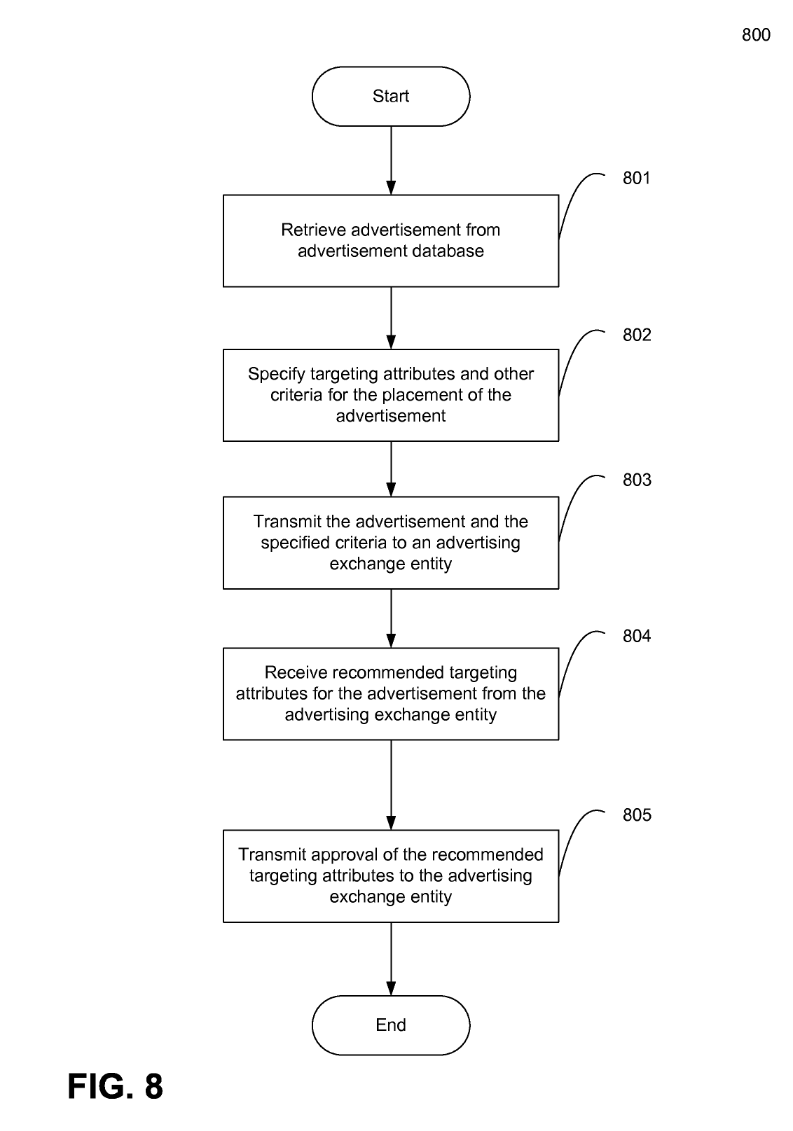

The operation of the advertising entity 701 is illustrated in the flowchart 800 depicted in FIG. 8. At step 801, the advertising server 704 retrieves an advertisement from the advertising database 705. At step 802, the advertising server 704 specifies targeting attributes and other criteria for the placement of the advertisement. At step 803, the advertising server 704 transmits the advertisement and the specified criteria to the advertising exchange entity 703. At step 804, upon transmitting the advertisements and the specified criteria, the advertising entity receives recommended targeting attributes for the advertisement from the advertising exchange entity 703. At step 805, the advertising server transmits an approval of the recommended targeting attributes to the advertising exchange entity 703.

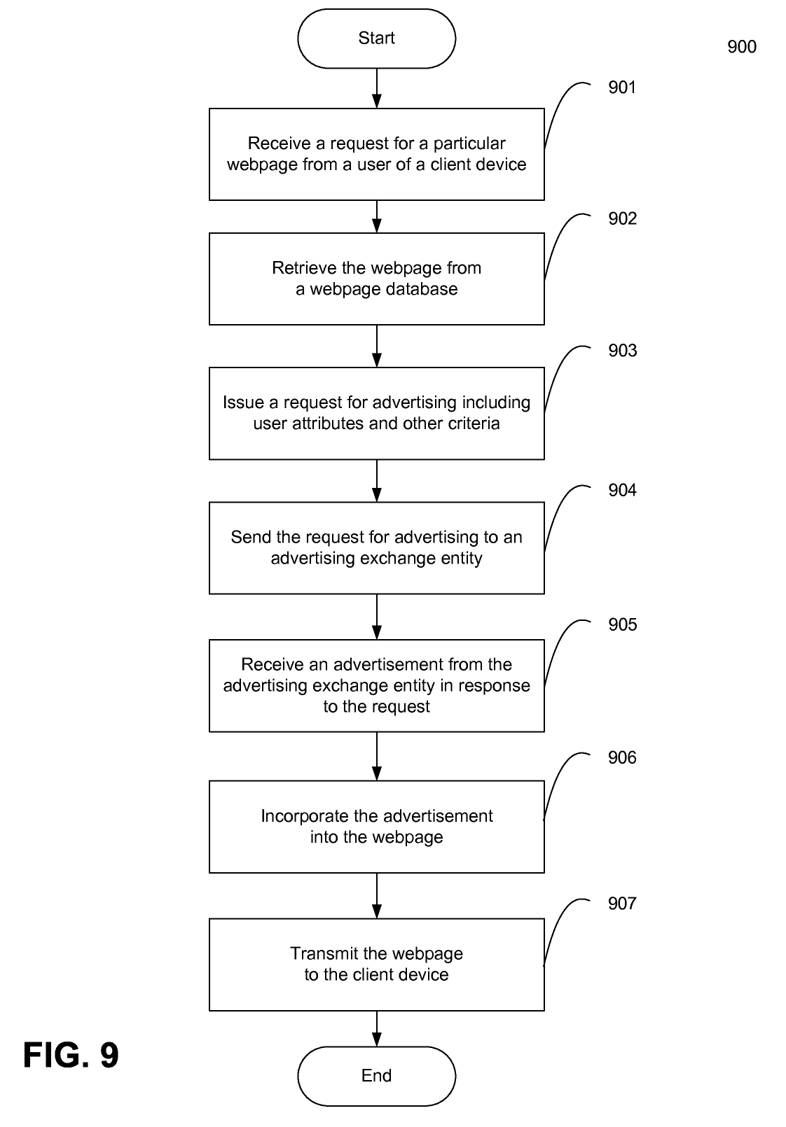

The operation of the content portal 702 is illustrated in the flowchart 900 depicted in FIG. 9. At step 901, the web server 710 receives a request for a particular webpage from a user of any device from among client devices 713-716. At step 902, the web server 710 retrieves the webpage from the webpage database 712. At step 903, the web server 710 issues a request for advertising including user attributes and other criteria as described above. At step 904, the web server 710 sends the request for advertising to the advertising exchange entity 703. At step 905, the web server 710 receives an advertisement from the advertising exchange entity 703 in response to the request. At step 906, the web server 710 incorporates the advertisement into the webpage. At step 907, the web server 710 transmits the webpage to the client device.

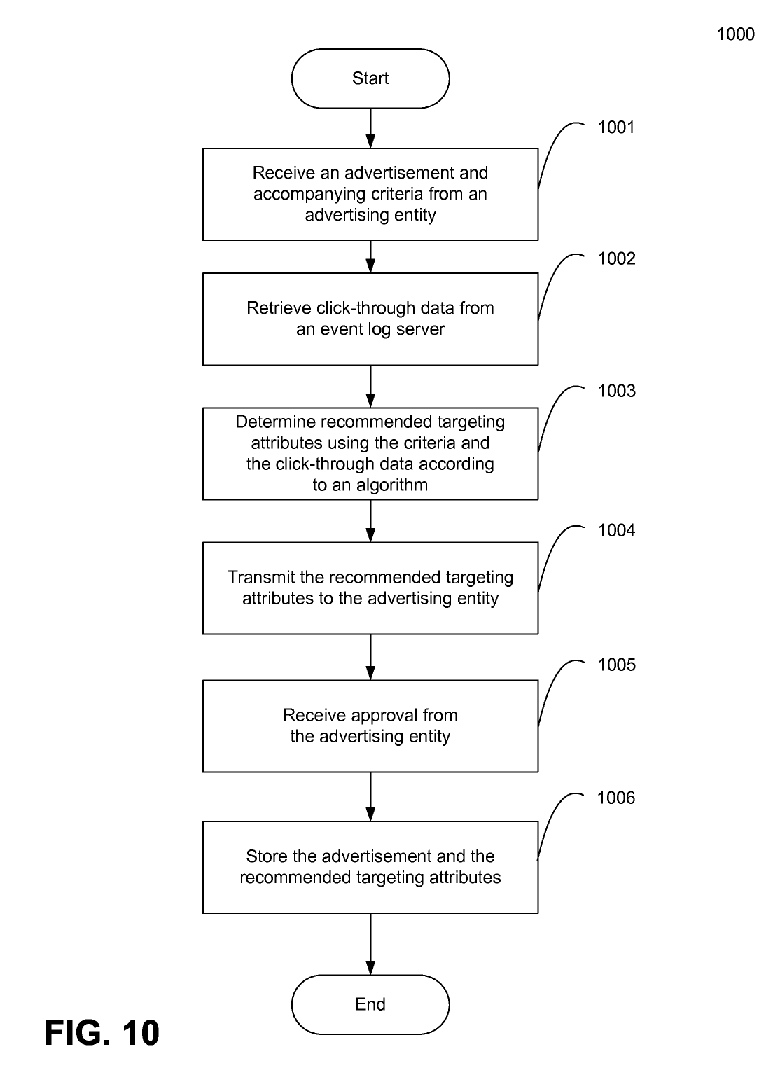

The operation of the advertising exchange entity 703 as it interacts with the advertising entity 701 is illustrated in the flowchart 1000 depicted in FIG. 10. At step 1001, the advertising exchange server 706 receives an advertisement and accompanying criteria from the advertising entity 701. At step 1002, the advertising exchange server 706 retrieves click-through data from the event log server 709. At step 1003, the advertising exchange server 706 determines recommended targeting attributes using the criteria and the click-through data according to an algorithm. The algorithm may be based on any of the embodiments disclosed herein. At step 1004, the advertising exchange server 706 transmits the recommended targeting attributes to the advertising entity 701 and awaits approval. At step 1005, the advertising exchange server 706 receives approval from the advertising entity 701. At step 1006, the advertising exchange server 706 stores the advertisement and the recommended targeting attributes in the advertisement database 707.

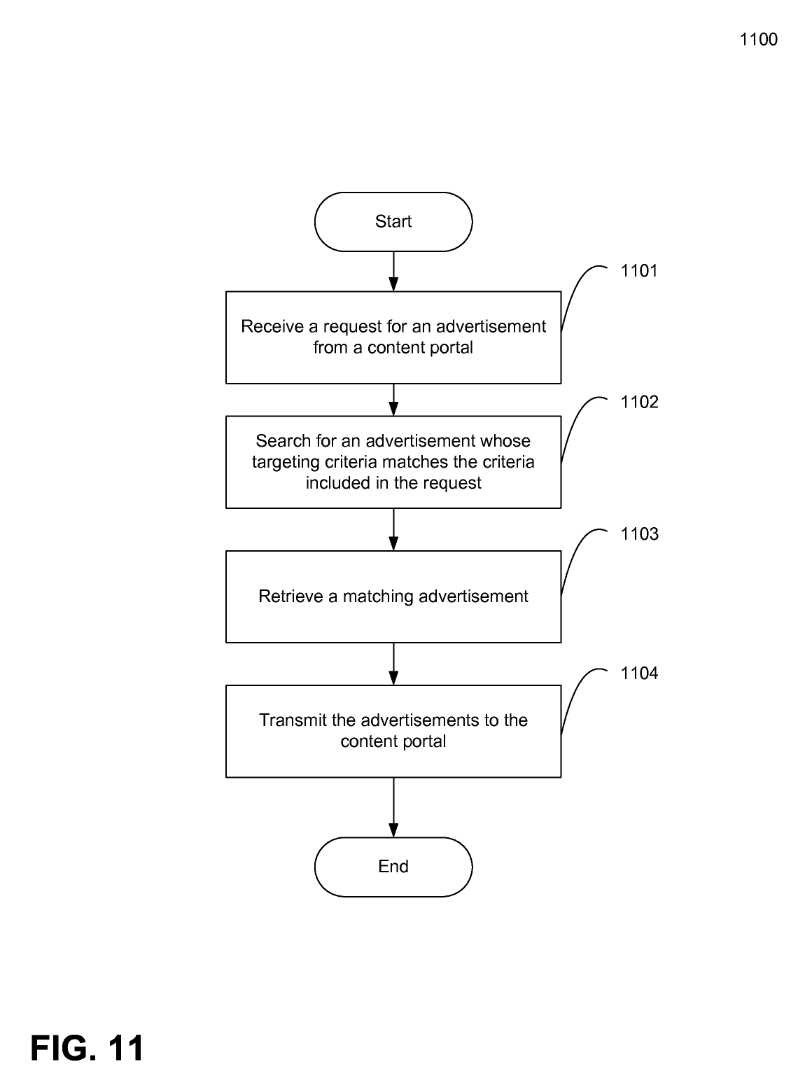

The operation of the advertising exchange entity 703 as it interacts with the content portal 702 is illustrated in the flowchart 1100 depicted in FIG. 11. At step 1101, the advertising exchange server 706 receives a request for an advertisement from the content portal 702. At step 1102, the advertising exchange server 706 searches the advertisement database 707 for an advertisement whose recommended targeting attributes, advertiser-specified targeting attributes, and other accompanying criteria matches the user attributes and other criteria included in the request. At step 1103, the advertising exchange server 706 retrieves a matching advertisement. At step 1104, the advertising exchange server 706 transmits the advertisement to the content portal 702.

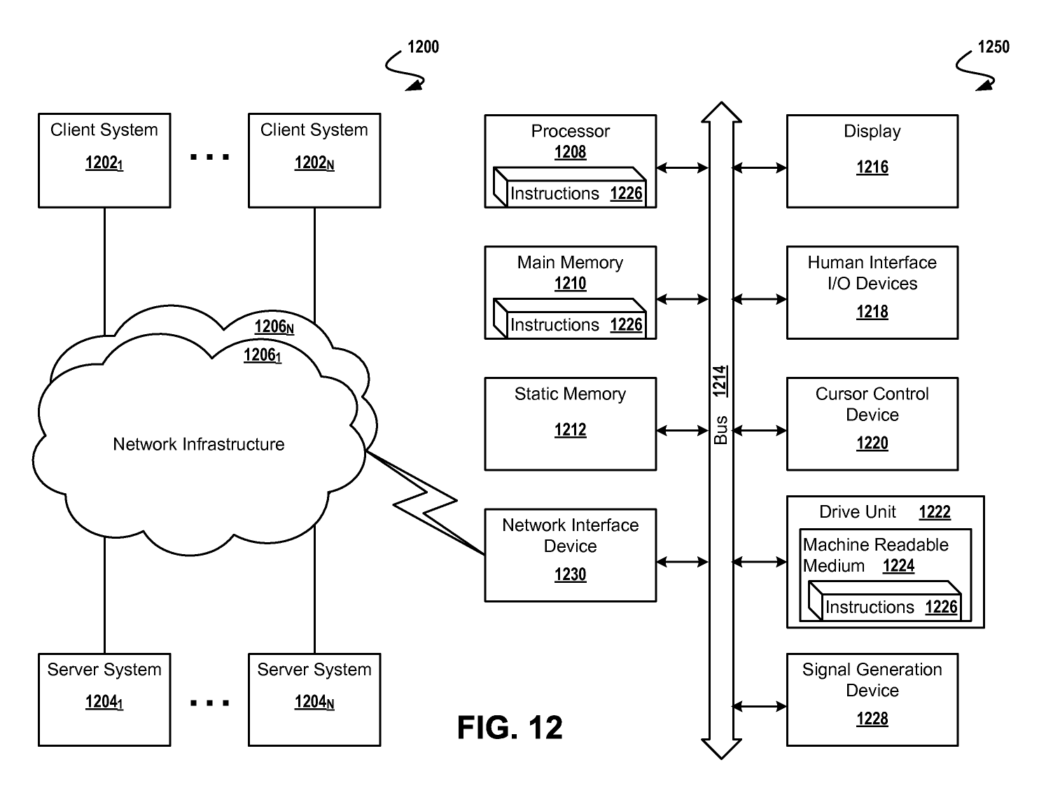

FIG. 12 is a diagrammatic representation of a network 1200, including nodes for client computer systems 1202₁ through 1202_{N}, nodes for server computer systems 1204₁ through 1204_{N}, nodes for network infrastructure 1206₁ through 1206_{N}, any of which nodes may comprise a machine 1250 within which a set of instructions for causing the machine to perform any one of the techniques discussed above may be executed. The embodiment shown is purely exemplary, and might be implemented in the context of one or more of the figures herein.

Any node of the network 1200 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1250 includes a processor 1208 (e.g. a processor core, a microprocessor, a computing device, etc), a main memory 1210 and a static memory 1212, which communicate with each other via a bus 1214. The machine 1250 may further include a display unit 1216 that may comprise a touch-screen, or a liquid crystal display (LCD), or a light emitting diode (LED) display, or a cathode ray tube (CRT). As shown, the computer system 1250 also includes a human input/output (I/O) device 1218 (e.g. a keyboard, an alphanumeric keypad, etc), a pointing device 1220 (e.g. a mouse, a touch screen, etc), a drive unit 1222 (e.g. a disk drive unit, a CD/DVD drive, a tangible computer readable removable media drive, an SSD storage device, etc), a signal generation device 1228 (e.g. a speaker, an audio output, etc), and a network interface device 1230 (e.g. an Ethernet interface, a wired network interface, a wireless network interface, a propagated signal interface, etc).

The drive unit 1222 includes a machine-readable medium 1224 on which is stored a set of instructions (i.e. software, firmware, middleware, etc) 1226 embodying any one, or all, of the methodologies described above. The set of instructions 1226 is also shown to reside, completely or at least partially, within the main memory 1210 and/or within the processor 1208. The set of instructions 1226 may further be transmitted or received via the network interface device 1230 over the network bus 1214.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

1. A computer implemented method for recommending targeting attributes for advertising campaigns, the method comprising:
receiving, at a computer, at least one advertising campaign and a corresponding plurality of advertiser-specified targeting attributes from an advertising entity, wherein the advertiser-specified targeting attributes specify criteria to select users to receive the advertising campaign and webpage content criteria for displaying the advertising campaigns;
receiving, at a computer, historical click-through data for previous advertising campaigns, comprising click through rates, and targeting attributes;
selecting a machine learning model for the computation of recommended targeting attributes; and
determining, in a computer, using the machine learning model and the historical click-through data, at least one recommended targeting attribute for an advertising campaign.

2. The computer implemented method of claim 1, wherein determining at least one recommended targeting attribute comprises:
modeling, using a computer, the advertising campaigns and the advertiser-specified targeting attributes as an advertiser-specified targeting attributes matrix with at least one advertising campaigns vector and at least one targeting attributes vector, the advertiser-specified targeting attributes matrix comprising a plurality of binary values indicating whether a particular targeting attribute from among a plurality of targeting attributes has been specified for a particular advertising campaign; and
modeling, using a computer, the historical click-through data as an advertising campaign user attribute matrix with at least one advertising campaigns vector and at least one user attributes vector, the advertising campaign user attribute matrix comprising a plurality of values indicating the frequency that a particular user attribute occurred in clicks corresponding to a particular advertising campaign.

3. The computer implemented method of claim 4, wherein determining at least one recommended targeting attribute further comprises:
factorizing the advertiser-specified targeting attributes matrix into a first factorized matrix and a second factorized matrix, wherein the advertising campaigns and the targeting attributes are mapped to a joint latent factor space comprising a plurality of latent factors; and
ranking, using the first factorized matrix and the second factorized matrix, the targeting attributes for each advertising campaign based on a plurality of weight values in the first factorized matrix corresponding to the targeting attributes and each advertising campaign.

4. The computer implemented method of claim 5, wherein determining at least one recommended targeting attribute further comprises:
determining a threshold value; and
selecting as the recommended targeting attribute for each advertising campaign a targeting attribute whose corresponding weight value exceeds the threshold value.

5. The computer implemented method of claim 4, wherein the advertiser-specified targeting attributes matrix is factorized using an algorithm regularized to ensure at least one of:
consistency with the plurality of advertiser-specified targeting attributes, using Frobenius norm;
consistency with similarity to user attributes; and
sparseness of the latent factors, by regularizing the first factorized matrix and the second factorized matrix.

6. The computer implemented method of claim 1, wherein determining at least one recommended targeting attribute comprises:
modeling, using a computer, the advertising campaigns and the advertiser-specified targeting attributes as a plurality of advertiser-specified targeting attributes binary vectors, the advertiser-specified targeting attributes binary vectors comprising a plurality of binary values indicating whether a particular targeting attribute from among a plurality of targeting attributes has been specified for a particular advertising campaign.

7. The computer implemented method of claim 6, wherein determining at least one recommended targeting attribute further comprises:
modeling, using a computer, the historical click-through data as a plurality of advertising campaign user attribute binary vectors, the advertising campaign user attribute binary vectors comprising a plurality of binary values indicating whether a click corresponding to a particular advertising campaign came from a user with a particular user attribute.

8. The computer implemented method of claim 7, wherein determining at least one recommended targeting attribute further comprises:
formulating, using a computer, a plurality of Boltzmann machines corresponding to the advertising campaigns;
training, using a computer, the Boltzmann Machines with the advertising campaign user attribute binary vectors and the advertiser-specified targeting attributes binary vectors;
deriving, in a computer, using the trained Boltzmann Machines a plurality of probability values corresponding to each element of each advertiser-specified targeting attributes binary vector; and
ranking the targeting attributes for each advertising campaign based on the targeting attributes' corresponding probability values.

9. The computer implemented method of claim 8, wherein determining at least one recommended targeting attribute further comprises:
determining a probability threshold; and
selecting as the at least one recommended targeting attribute for each advertising campaign the targeting attribute whose corresponding probability value exceeds the threshold value.

10. The computer implemented method of claim 1, wherein determining at least one recommended targeting attribute comprises:
defining a plurality of neighborhoods of advertising campaigns corresponding to the advertising campaigns, wherein a neighborhood comprises previous advertising campaigns that are similar to an advertising campaign;
formulating, in a computer, a plurality of local regression models using the neighborhoods of advertising campaigns;
deriving, in a computer, a plurality of advertising campaign vectors using the local regression models, wherein each of the advertising campaigns vectors comprise a plurality of weights corresponding to a plurality of targeting attributes; and
ranking, using a computer, the targeting attributes for each advertising campaign based on the targeting attributes' corresponding weights.

11. The computer implemented method of claim 10, wherein determining at least one recommended targeting attribute further comprises:
determining, in a computer, a threshold weight value; and
selecting, for each advertising campaign vector, as the recommended targeting attribute at least one targeting attribute whose corresponding weight exceeds the threshold weight value.

12. The computer implemented method of claim 1, further comprising:
generating, using a computer, at least one explanation parameter from the recommended targeting attribute and the advertising campaigns, wherein the explanation parameter specifies reasons for the recommended targeting attribute; and
transmitting, using a computer, the explanation parameter to the advertising entity.

13. A computer readable medium comprising (or that stores) a set of instructions which, when executed by a computer, cause the computer to execute steps for recommending targeting attributes for advertising campaigns, the steps comprising:
receiving, at a computer, at least one advertising campaign and a corresponding plurality of advertiser-specified targeting attributes from an advertising entity, wherein the advertiser-specified targeting attributes specify criteria to select users to receive the advertising campaign and webpage content criteria for displaying the advertising campaigns;
receiving, at a computer, historical click-through data for previous advertising campaigns, comprising click through rates, and targeting attributes;
selecting a machine learning model for the computation of recommended targeting attributes; and
determining, in a computer, using the machine learning model and the historical click-through data, at least one recommended targeting attribute for an advertising campaign.

14. The computer readable medium of claim 13, wherein the step of determining at least one recommended targeting attribute comprises:
modeling, using a computer, the advertising campaigns and the advertiser-specified targeting attributes as an advertiser-specified targeting attributes matrix with at least one advertising campaigns vector and at least one targeting attributes vector, the advertiser-specified targeting attributes matrix comprising a plurality of binary values indicating whether a particular targeting attribute from among a plurality of targeting attributes has been specified for a particular advertising campaign;
modeling, using a computer, the historical click-through data as an advertising campaign user attribute matrix with at least one advertising campaigns vector and at least one user attributes vector, the advertising campaign user attribute matrix comprising a plurality of values indicating the frequency that a particular user attribute occurred in clicks corresponding to a particular advertising campaign;
factorizing the advertiser-specified targeting attributes matrix into a first factorized matrix and a second factorized matrix, wherein the advertising campaigns and the targeting attributes are mapped to a joint latent factor space comprising a plurality of latent factors; and
ranking, using the first factorized matrix and the second factorized matrix, the targeting attributes for each advertising campaign based on a plurality of weight values in the first factorized matrix corresponding to the targeting attributes and each advertising campaign.

15. The computer readable medium of claim 14, wherein the step of determining at least one recommended targeting attribute for the plurality of advertising campaigns further comprises:
determining a threshold value; and
selecting as the recommended targeting attribute for each advertising campaign a targeting attribute whose corresponding weight value exceeds the threshold value.

16. The computer readable medium of claim 15, wherein the advertiser-specified targeting attributes matrix is factorized using an algorithm regularized to ensure at least one of:
consistency with the plurality of advertiser-specified targeting attributes, using Frobenius norm;
consistency with similarity to user attributes; and
sparseness of the latent factors, by regularizing the first factorized matrix and the second factorized matrix.

17. The computer readable medium of claim 13, wherein the step of determining at least one recommended targeting attribute comprises:
modeling, using a computer, the advertising campaigns and the advertiser-specified targeting attributes as a plurality of advertiser-specified targeting attributes binary vectors, the advertiser-specified targeting attributes binary vectors comprising a plurality of binary values indicating whether a particular targeting attribute from among a plurality of targeting attributes has been specified for a particular advertising campaign;
modeling, using a computer, the historical click-through data as a plurality of advertising campaign user attribute binary vectors, the advertising campaign user attribute binary vectors comprising a plurality of binary values indicating whether a click corresponding to a particular advertising campaign came from a user with a particular user attribute;
formulating, using a computer, a plurality of Boltzmann machines corresponding to the advertising campaigns;
training, using a computer, the Boltzmann Machines with the advertising campaign user attribute binary vectors and the advertiser-specified targeting attributes binary vectors;
deriving, in a computer, using the trained Boltzmann Machines a plurality of probability values corresponding to each element of each advertiser-specified targeting attributes binary vector; and
ranking the targeting attributes for each advertising campaign based on the targeting attributes' corresponding probability values.

18. The computer readable medium of claim 17, wherein the step of determining at least one recommended targeting attribute further comprises:
determining a probability threshold; and
selecting as the at least one recommended targeting attribute for each advertising campaign the targeting attribute whose corresponding probability value exceeds the threshold value.

19. The computer readable medium of claim 13, wherein the step of determining at least one recommended targeting attribute comprises:
defining a plurality of neighborhoods of advertising campaigns corresponding to the advertising campaigns, wherein a neighborhood comprises previous advertising campaigns that are similar to an advertising campaign;
formulating, in a computer, a plurality of local regression models using the neighborhoods of advertising campaigns;
deriving, in a computer, a plurality of advertising campaign vectors using the local regression models, wherein each of the advertising campaigns vectors comprise a plurality of weights corresponding to a plurality of targeting attributes; and
ranking, using a computer, the targeting attributes for each advertising campaign based on the targeting attributes' corresponding weights.

20. The computer readable medium of claim 19, wherein the step of determining at least one recommended targeting attribute further comprises:
determining, in a computer, a threshold weight value; and
selecting, for each advertising campaign vector, as the recommended targeting attribute at least one targeting attribute whose corresponding weight exceeds the threshold weight value.
